(19) United States
(12) Patent Application Publication
(10) Pub. No.: US 2019/0122055 A1
(43) Pub. Date: Apr. 25, 2019

(54) METHOD AND APPARATUS FOR DETECTING AT LEAST ONE CONCEALED OBJECT IN ROAD TRAFFIC FOR A VEHICLE USING A PASSIVE VEHICLE SENSOR

(71) Applicant: Robert Bosch GmbH, Stuttgart (DE)

(72) Inventors: Ulrich Stopper, Gerlingen (DE); Petko Faber, Renningen (DE); Uwe Maehnert, Bietigheim-Bissingen (DE)

(21) Appl. No.: 16/148,728

(22) Filed: Oct. 1, 2018

(30) Foreign Application Priority Data
Oct. 25, 2017 (DE) 102017219056.6

(51) Int. Cl. G06K 9/00; B60W 50/00; G01V 8/10

(52) U.S. Cl. CPC G06K 9/00805; B60W 2550/10; G01V 8/10; B60W 50/0098

(57) ABSTRACT

A method is described for detecting at least one concealed object in road traffic for a vehicle using a passive vehicle sensor, the method encompassing firstly a step of reading in an input signal furnished by the passive vehicle sensor, and the input signal representing a light beam that was reflected or scattered from a surface of an object located on the roadway and/or at the roadside. Lastly, the method encompasses a step of processing the input signal in order to detect the concealed object in road traffic.

### FIELD OF THE INVENTION

The invention proceeds from an apparatus or a method. A further subject of the present invention is a computer program.

### BACKGROUND INFORMATION

The use of sensors to implement driver assistance functions in road traffic has now been existing art for several decades. The principal task performed by the sensors is that of detecting objects, for example vehicles or pedestrians, as well as roadway markings. The technologies used in this context can be subdivided in principle into active sensor equipment and passive sensor equipment. Active sensors themselves emit electromagnetic waves or acoustic waves, and detect waves reflected shortly thereafter from the objects to be detected. These include radar sensors, lidar systems, and ultrasonic sensors. Passive sensors do not themselves emit any waves, and merely receive light that is generated outside the own vehicle. These include principally video cameras.

### SUMMARY

In light of the above, the approach presented here presents a method for detecting at least one concealed object in road traffic for a vehicle using a passive vehicle sensor; a method for applying control to a component of the vehicle; furthermore an apparatus that uses that method; and lastly a corresponding computer program. Also described are advantageous refinements of and improvements to the apparatus as described herein.

The approach presented here can be used as a method for a vehicle in which objects in road traffic which are not directly visible can be detected optically using a passive vehicle sensor, without utilizing radar, lidar, or ultrasonic technologies for that purpose.

A method is presented for detecting at least one concealed object in road traffic for a vehicle using a passive vehicle sensor, the method encompassing the following steps:

reading in an input signal furnished by the passive vehicle sensor, the input signal representing a light beam that was reflected or scattered from a surface of an object located on the roadway and/or at the roadside; and

processing the input signal in order to detect the concealed object in road traffic.

The concealed object can be an oncoming vehicle. A “vehicle” can be a vehicle for passenger transport, for example a vehicle driving in highly automated fashion. The passive vehicle sensor can be a video camera and/or a sensor that does not actively send out signals. The input signal can represent a light beam that was reflected or scattered from a surface of an object located on a roadway and/or at the roadside.

According to an embodiment, the reading-in step and/or processing step can be executed in a computer unit external to the vehicle. Such a computer unit external to the vehicle can be constituted, for example, by a server of a cloud. Such an embodiment offers the advantage that the performance capability of computer units for executing steps of the approach presented here in the vehicle can be minimized, with the result that manufacturing costs can be reduced.

According to an embodiment, a result of a signal processing performed in the computer unit external to the vehicle can be conveyed back to a component of the vehicle in the processing step. Such an embodiment of the approach presented here offers the advantage of applying control to a component of the vehicle, for example a component of a driver assistance system or high-beam assistant, by way of a signal (that depends on or represents the result of the signal processing), so that once again the performance capability of computer units for executing steps of the approach presented here in the vehicle can be minimized, in order to reduce manufacturing costs.

According to an embodiment, the input signal can be processed in the processing step using a neural network. Such an embodiment of the approach proposed here offers the advantage of very efficient trainability thanks to use of the neural network.

According to an embodiment, a time course of the input signal can be evaluated in the processing step. Such an embodiment of the approach proposed here advantageously utilizes the fact that processing of the time course of the input signal often reduces the disadvantageous effects of measurement inaccuracies contained in the input signal. This makes possible, for instance, a more reliable estimate of the properties of the object to be detected or a more reliable prognosis of future values of the input signals, so that greater usefulness can thereby be gained from processing of the input signal.

According to an embodiment, at least one color information item of the light beam represented by the input signal can be evaluated in the processing step. A “color information item” can be understood, for example, as an information item that is contained in the wavelength of the light or is modeled or represented thereby. Such an embodiment of the approach proposed here offers the advantage that further improvement or greater precision in the detection of the concealed object can be achieved thanks to evaluation of the color information item.

According to an embodiment, an information item regarding the object is ascertained using the color information item in the processing step. Such an information item can be, for example, a travel direction or movement direction of the object with reference to the vehicle. Such an embodiment offers the advantage that once again a further improvement in detection of the concealed object can be achieved. For example, upon detection of red light portions represented in the input signal it is possible to infer that the object is probably a concealed preceding vehicle, portions of whose rear-facing light are contained in the input signal. It is thereby possible, for example, for a driver assistance system in the vehicle to assess a risk to the vehicle as a result of the concealed object as being less probable than if white light portions, which can be emitted, for example, from an oncoming vehicle constituting a concealed object, were represented in the input signal.

A method for applying control to a component of the vehicle is presented, the method encompassing a step of outputting, in response to a detected object, a control signal for applying control to the component of the vehicle. Such a component of the vehicle can represent, for example, a driver assistance system or personal protection system of the vehicle. Such an embodiment of the approach presented here offers the advantage that the usefulness of the component of the vehicle can be further enhanced by taking into consideration the detected concealed object.

This method can be implemented, for example, in software or hardware or in a mixed form of software and hardware, for example in a control unit.

The approach presented here furthermore creates an apparatus that is embodied to carry out, control, or implement, in corresponding devices, the steps of a variant of a method presented here. This variant embodiment of the invention in the form of an apparatus also allows the object on which the invention is based to be achieved quickly and efficiently.

The apparatus can have for that purpose at least one computation unit for processing signals or data, at least one memory unit for storing signals or data, at least one interface to a sensor or to an actuator for reading in sensor signals from the sensor or for outputting data signals or control signals to the actuator, and/or at least one communication interface for reading in or outputting data that are embedded in a communication protocol. The computation unit can be, for example, a signal processor, a microcontroller, or the like, and the memory unit can be a flash memory, an EEPROM, or a magnetic memory unit. The communication interface can be embodied to read in or output data wirelessly and/or in wire-based fashion; a communication interface that can read in or output data in wire-based fashion can read in said data, for example, electrically or optically from a corresponding data transfer line or output said data into a corresponding data transfer line.

An “apparatus” can be understood in the present case as an electrical device that processes sensor signals and, as a function thereof, outputs control signals and/or data signals. The apparatus can have an interface that can be embodied on the basis of hardware and/or software. With a hardware-based embodiment the interfaces can be, for example, part of a so-called “system ASIC” that contains a wide variety of functions of the apparatus. It is also possible, however, for the interfaces to be separate integrated circuits or to be made up at least in part of discrete constituents. With a software-based embodiment the interfaces can be software modules that are present, for example, on a microcontroller alongside other software modules.

Also advantageous is a computer program product or computer program having program code that can be stored on a machine-readable medium or memory medium such as a semiconductor memory, a hard-drive memory, or an optical memory and can be used to carry out, implement, and/or control the steps of the method in accordance with one of the embodiments described above, in particular when the program product or program is executed on a computer or on an apparatus.

### BRIEF DESCRIPTION OF THE DRAWINGS

FIG. 1 is a schematic cross-sectional view of a vehicle having an apparatus for detecting at least one concealed object in road traffic, according to an exemplifying embodiment.

FIG. 2 is a schematic plan view of an exemplifying traffic situation for use of a method for detecting a concealed object in road traffic, according to an exemplifying embodiment.

FIG. 3 is a view of a camera image of a vehicle sensor for evaluation using a method according to an exemplifying embodiment.

FIG. 4 shows a flow chart of a method for detecting a concealed object in road traffic, according to an exemplifying embodiment.

FIG. 5 shows a flow chart of an exemplifying embodiment of a method for detecting a concealed object in road traffic for a vehicle using a passive vehicle sensor, and a subsequent method for applying control to a component of the vehicle, according to an exemplifying embodiment.

### DETAILED DESCRIPTION

In the description below of favorable exemplifying embodiments of the present invention, identical or similar reference characters are used for the elements that are depicted in the various Figures and function similarly, repeated description of those elements being omitted.

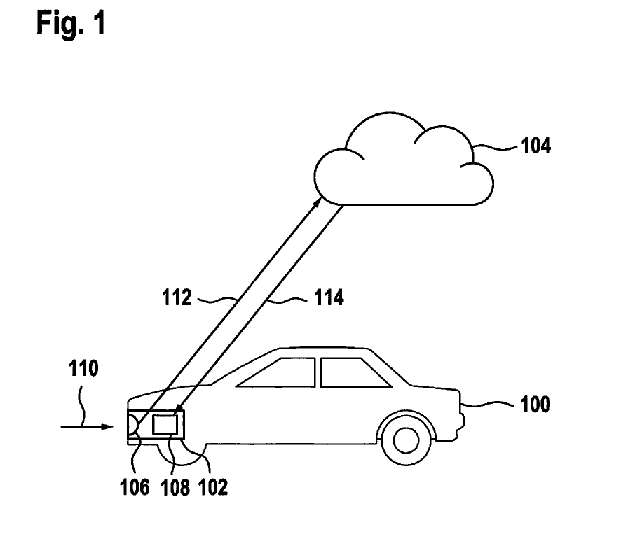

FIG. 1 is a schematic cross-sectional view of a vehicle 100 having an apparatus 102 for detecting a concealed object in road traffic, according to an exemplifying embodiment. Vehicle 100 encompasses apparatus 102 for detecting a concealed object in road traffic, as well as a computer unit 104; alternatively, computer unit 104 can also be an external server, for example a cloud computer. Apparatus 102 for detecting a concealed object in road traffic utilizes a passive vehicle sensor 106 and outputs a signal to a component 108. According to an exemplifying embodiment, the passive vehicle sensor 106 can be a video camera. The video camera does not itself emit any electromagnetic waves, but receives a light beam 110 that is generated outside vehicle 100. According to an exemplifying embodiment, component 108 can be a driver assistance system, a headlight control unit, a steering unit, a personal protection system, or a braking unit of vehicle 100.

Vehicle sensor 106 is embodied to furnish an input signal 112 to computer unit 104. Input signal 112 represents light beam 110 (or portions of an image acquired by vehicle sensor 106) that has been reflected or scattered from a surface of an object located on a roadway and/or at the roadside. Computer unit 104 is embodied to read in input signal 112 and, using the read-in input signal 112, to furnish to component 108 of vehicle 100 a control signal 114 in response to an (actually) detected object, control signal 114 representing an information item for applying control to component 108 of vehicle 100.

One objective of the method for detecting a concealed object in road traffic can be viewed as that of making a passive vehicle sensor 106, for example a video camera, capable of detecting concealed objects in road traffic, and thereby enhancing driving safety and driving comfort. In some cases the result could also be that installation of an active sensor in vehicle 100 is omitted and that a passive vehicle sensor 106, which does not have the disadvantages of an active sensor, is installed in its stead. Those disadvantages include, for instance, large outlays for design and calibration, consumption of a large amount of space and energy, and requirements with regard to electromagnetic and environmental compatibility. If the result thereof were that fewer sensors in total were installed in vehicle 100, the manufacturing costs for each vehicle 100 could be decreased.

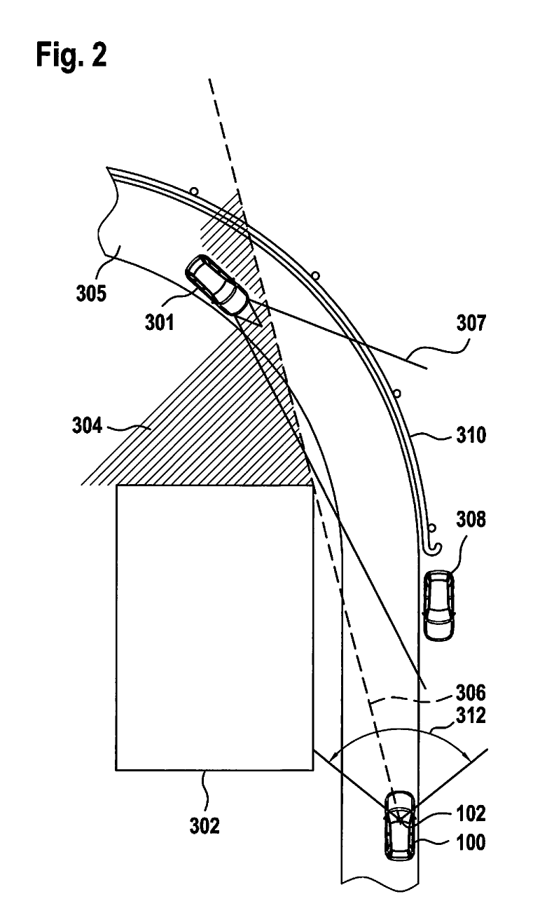

FIG. 2 is a schematic plan view of an exemplifying traffic situation for the use of a method for detecting a concealed object 301 in road traffic, according to an exemplifying embodiment.

A vehicle sensor for electromagnetic waves, installed in vehicle 100, of an apparatus 102 for detecting a concealed object, for example a camera that images visible or invisible light, detects an object 301 on the road ahead on the basis of electromagnetic waves that are generated by object 301 to be detected and were then reflected or scattered at the surface of another object before they encounter vehicle sensor 106 for further processing in apparatus 102 for detecting a concealed object. According to an exemplifying embodiment the method, presented in further detail below, for detecting a concealed object 301 in road traffic, makes possible the recognition, without using active sensor equipment, i.e. without needing to emit its own electromagnetic waves, of objects 301 that are not located in the directly visible region of the road ahead.

Other traffic participants can be recognized by vehicle sensor 106 even though they are not located in the directly visible region of the vehicle sensor, for example around a curve. Reaction times for initiating actions in certain application instances can thereby be considerably reduced. This enhances safety and driving comfort.

For illustration, FIG. 2 depicts a traffic situation for application of the method for detecting a concealed object in road traffic. It is night, and own vehicle 100 is approaching a curve in roadway 305. A concealed object 301, which according to an exemplifying embodiment can be an oncoming other vehicle 301, is in the curve in the region that is not directly visible. This region that is not directly visible is created by the fact that a further object 302, for example a residential building, is located between vehicle sensor 106 installed in vehicle 100 and vehicle 301 that is to be detected, and blocks the view of other vehicle 301. The result is a “dead zone” 304 between object 302 and a sight line 306 of vehicle 100 toward the outermost point of object 302. That zone 304 is the region that is not directly visible. The headlights of other vehicle 301 are switched on and project a light cone 307 into the environment. Said cone strikes an object 308 and an object 310 that are located at the roadside. In the example illustrated, object 308 is a third vehicle and object 310 is a guardrail 310. Light cone 307 is reflected or diffusely scattered at the surfaces of the third object constituting object 308 and/or at guardrail 310 constituting object 310. A camera, which detects an angle of view 312 in front of vehicle 100, is in use in vehicle sensor 106.

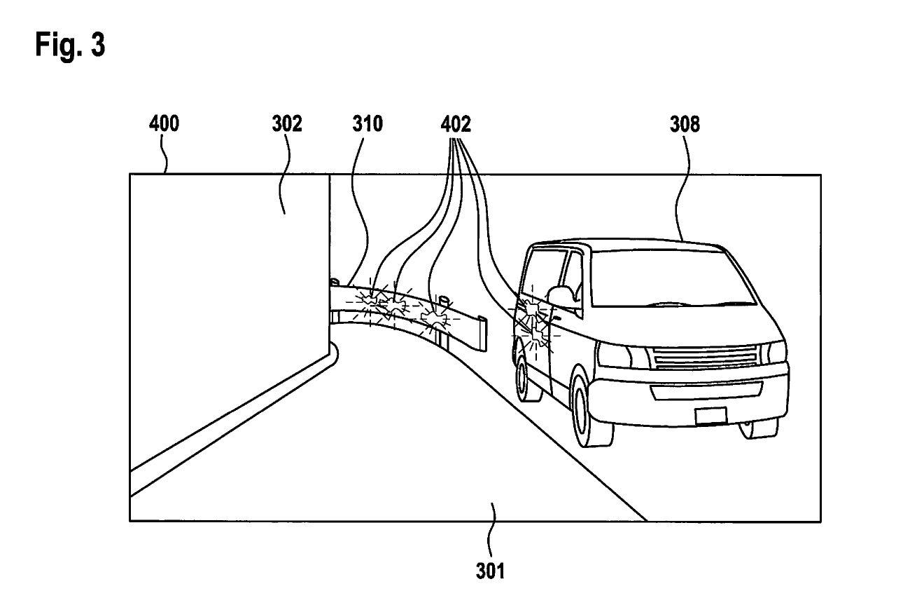

FIG. 3 is a view of a camera image 400 of a vehicle sensor in accordance with an exemplifying embodiment. Camera image 400 is, for example, the view, depicted by way of FIG. 2, of an exemplifying traffic situation for use of a method for detecting a concealed object in road traffic, from the viewpoint of the own vehicle.

Camera image 400 is generated by the vehicle sensor of the own vehicle by processing the light received in angle of view 312, and represents input signal 112 in accordance with the depiction of FIG. 1. The oncoming other vehicle is not visible in camera image 400 of the vehicle sensor because it is concealed by object 302. On the other hand, however, a plurality of bright light spots 402, caused by the reflected or scattered headlight light of a concealed vehicle, are visible on the surfaces of the third vehicle (object 308) and/or of the guardrail (object 310). The vehicle sensor detects light spots 402 and supplies or analyzes input signal 112 that results therefrom.

The result of a signal analysis accomplished in computer unit 104, for example, is that an oncoming vehicle is located behind object 302. Although the oncoming vehicle is not directly visible, the own vehicle can now, for example, already dim its own headlights (not depicted) from high beams to low beams by the fact that a corresponding control signal 114 is sent to a vehicle component 108. It is thereby possible to prevent the driver of the oncoming vehicle from being dazzled.

Conventional high-beam assistants cannot dim until the oncoming traffic is directly visible. It is then often already too late, however, to prevent the oncoming traffic from being dazzled by the high beam. Because the scenario described does not represent an unusual situation, and because numerous high-beam assistants based on passive sensors are currently being produced, it can be assumed that such dazzling events occur frequently. Utilization of the method presented here would allow a large portion of these unpleasant and possibly even hazardous events to be avoided. If the own vehicle is moving at elevated speed, the vehicle speed can additionally also automatically be slightly reduced in order to decrease the risk of accident. In favorable conditions, individual actions such as adapting the speed can already be initiated several seconds before the oncoming vehicle becomes directly visible, so that no impairments in driving convenience occur. In some circumstances, timely initiation of a smooth speed reduction can prevent abrupt emergency braking that, without use of the invention, would be necessary in order to prevent a collision.

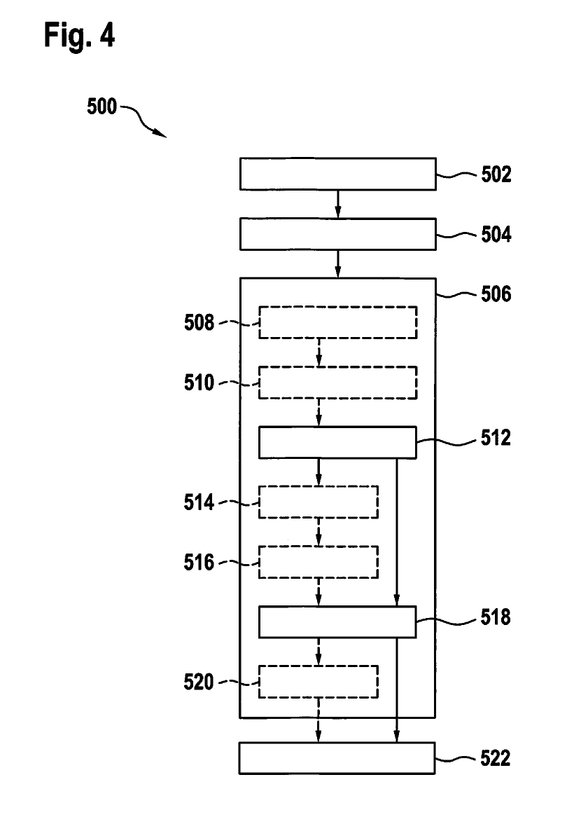

FIG. 4 shows a flow chart 500 of a method for detecting a concealed object in road traffic, according to an exemplifying embodiment. In a step 502, the vehicle sensor receives electromagnetic waves, for example visible or invisible light, that are reflected or scattered from the surface of an object located at the roadside or on the roadway. (The electromagnetic waves are explicitly not waves that were generated by the own vehicle.) Those electromagnetic waves are converted in the (vehicle) sensor into an input signal. In a step 504, the input signal is conveyed to a computer unit. In a step 506, the input signal is analyzed in the computer unit using a software program. In an optional step 508 the software ascertains, in the context of analysis of the input signal, an incidence direction of the electromagnetic wave onto the vehicle sensor.

In a further optional step 510, the software associates the incidence direction ascertained in step 508 with an object which is already known from other measurements, for example measurements of another sensor, and whose surface has possibly reflected or scattered the electromagnetic wave. In a step 512, the software checks whether the input signal involves reflected or scattered electromagnetic waves. In an optional step 514, if the electromagnetic waves are reflected or scattered ones, the software ascertains the direction from which the electromagnetic wave was originally radiated prior to reflection or scattering, i.e. the original direction. In a further optional step 516, the software compares the original direction, ascertained in step 514, of the electromagnetic wave with a roadway geometry that is already known from other measurements or from map data. In a step 518, the software either directly uses the result of the signal check from step 512, or uses the result of the reconciliation between the original direction of the electromagnetic wave and the roadway geometry from step 516, to infer therefrom that an object that has generated the electromagnetic wave is located on the road ahead or in the vicinity thereof. In an optional step 520, the software carries out a further investigation of the input signal in order to assign the wave-generating object to a specific class, for example an oncoming or preceding passenger car or two-wheeled vehicle or a street light. The objective here is to specify more accurately the actions to be initiated in the subsequent step 512; for example, if the object is an oncoming vehicle, the own vehicle should dim its headlights, but if the object is a street light, the own vehicle should not dim its headlights. If it is inferred in step 518 that an object is located on the roadway ahead or in the vicinity thereof, in step 522 corresponding actions are initiated that possibly were more accurately specified in the optional step 520.

According to an exemplifying embodiment of the method, the computer unit recited in the description is not necessarily located in the vehicle. It is instead also possible to transfer the input signal, or a partial result of the signal processing subsequent thereto, to a computer unit that is not located in the own vehicle. An external computer unit of this kind could be located, for example, in a server, and transfer of the data can occur via radio. In this manifestation, one or more of the signal processing steps would be carried out on the external computer unit. The result of this vehicle-external signal processing can then be conveyed back to the vehicle that carries the vehicle sensor so that a control signal can be outputted for application of control to a component of the vehicle, for example the high-beam assistant.

According to an exemplifying embodiment of the method, the optional method steps 508, 510, 514, and 516 are omitted. An estimate is made directly from the input signal, for example using an artificial neural network, as to whether an object which generated the detected electromagnetic waves, and whose presence requires the initiation of actions, is located on the roadway ahead or in the vicinity thereof.

According to an exemplifying embodiment of the method, in order to make the signal processing result more robust it is possible to use methods based on the fact that additional information is obtained from the time course of the input signal. That information would not be available if only a “snapshot” of the vehicle sensor were evaluated at each point in time. For evaluation of the time course of the signal, for example, the input signal can be filtered in the time dimension, for example smoothed. If the vehicle sensor is an image-producing camera it is also possible, for example, to analyze over a defined time window the manner in which the brightness or shape of the observed light spots changes, so that conclusions regarding the origin of the light can be drawn therefrom. If an artificial neural network is used for signal evaluation, it can be structured in such a way that the data processed therein affect in part, over a longer period of time, the calculations taking place in the network; this is the case, for example, when a recurrent neural network is used.

According to an exemplifying embodiment of the method, color information can furthermore be evaluated in order to make the signal processing result more robust. The light striking the vehicle sensor can be spectrally dispersed for that purpose, for example, by the fact that it strikes a pixel array outfitted with color filters. The color analysis can be used in order to arrive at a more accurate conclusion as to how probable it is that the received light was generated by a vehicle headlight. For that purpose, the ascertained color or an ascertained spectral distribution is compared with a set of spectra stored in the software. The stored spectra derive from measurements that were carried out during the development phase using standardized vehicle headlights.

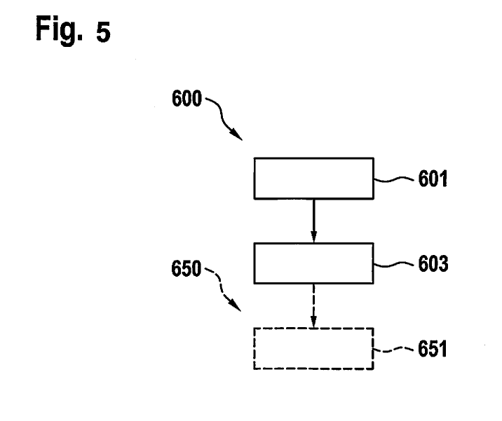

FIG. 5 shows a flow chart of an exemplifying embodiment of a method 600 for detecting a concealed object in road traffic for a vehicle using a passive vehicle sensor, and a subsequent method 650 for applying control to a component of the vehicle, according to an exemplifying embodiment. Methods 600 and 650 can be executed, for example, using the apparatus described with reference to FIG. 1 for detecting a concealed object in road traffic.

Method 600 encompasses a step 601 in which an input signal furnished by the passive vehicle sensor is read in, the input signal representing a light beam that was reflected or scattered from a surface of an object located on the roadway and/or at the roadside. In addition, in a step 603 the input signal is processed in order to detect the concealed object in road traffic.

For example, step 601 can correspond to steps 502 and 504 as depicted in FIG. 4, whereas step 603 corresponds to the steps labeled with the reference character 506 in FIG. 4.

Method 650 for applying control to a component of the vehicle encompasses both the steps of method 600 and a step 651 in which, in response to a detected object, a control signal is outputted in order to apply control to the component of the vehicle.

If an exemplifying embodiment encompasses an “and/or” relationship between a first feature and a second feature, this is to be read to mean that the exemplifying embodiment according to one embodiment has both the first feature and the second feature, and according to a further embodiment has either only the first feature or only the second feature.

What is claimed is:

1. A method for detecting at least one concealed object in road traffic for a vehicle using a passive vehicle sensor, the method comprising:
reading in an input signal furnished by the passive vehicle sensor, the input signal representing a light beam that was one of reflected and scattered from a surface of an object located at least one of on a roadway and at a roadside; and
processing the input signal in order to detect the concealed object in road traffic.

2. The method as recited in claim 1, wherein at least one of the reading-in step and the processing step is executed in a computer unit external to the vehicle.

3. The method as recited in claim 2, wherein a result of a signal processing performed in the computer unit external to the vehicle is conveyed back to a component of the vehicle in the processing step.

4. The method as recited in claim 1, wherein the input signal is processed in the processing step using a neural network.

5. The method as recited in claim 1, wherein a time course of the input signal is evaluated in the processing step.

6. The method as recited in claim 1, wherein at least one color information item of the light beam represented by the input signal is evaluated in the processing step.

7. The method as recited in claim 6, wherein an information item regarding the object is ascertained in the processing step using the color information item.

8. A method for applying control to a component of the vehicle, comprising:
reading in an input signal furnished by the passive vehicle sensor, the input signal representing a light beam that was one of reflected and scattered from a surface of an object located at least one of on a roadway and at a roadside;
processing the input signal in order to detect the concealed object in road traffic;
outputting, in response to the detected object, a control signal for applying control to the component of the vehicle.

9. An apparatus for detecting at least one concealed object in road traffic for a vehicle using a passive vehicle sensor, comprising:
an arrangement for reading in an input signal furnished by the passive vehicle sensor, the input signal representing a light beam that was one of reflected and scattered from a surface of an object located at least one of on a roadway and at a roadside; and
an arrangement for processing the input signal in order to detect the concealed object in road traffic.

10. A computer program that is configured to at least one of execute and control a method for detecting at least one concealed object in road traffic for a vehicle using a passive vehicle sensor, the method comprising:
reading in an input signal furnished by the passive vehicle sensor, the input signal representing a light beam that was one of reflected and scattered from a surface of an object located at least one of on a roadway and at a roadside; and
processing the input signal in order to detect the concealed object in road traffic.

11. A machine-readable memory medium on which is stored a computer program that is configured to at least one of execute and control a method for detecting at least one concealed object in road traffic for a vehicle using a passive vehicle sensor, the method comprising:
reading in an input signal furnished by the passive vehicle sensor, the input signal representing a light beam that was one of reflected and scattered from a surface of an object located at least one of on a roadway and at a roadside; and
processing the input signal in order to detect the concealed object in road traffic.
